(19) United States
(12) Patent Application Publication
(10) Pub. No.: US 2011/0057589 A1
(43) Pub. Date: Mar. 10, 2011

(54) COMPUTER FAN CONTROL SYSTEM

(75) Inventor: CHEN-KAI HUNG, Tu-Cheng (TW)

(73) Assignee: HON HAI PRECISION INDUSTRY CO., LTD., Tu-Cheng (TW)

(21) Appl. No.: 12/580,268

(22) Filed: Oct. 16, 2009

(30) Foreign Application Priority Data
Sep. 7, 2009 (CN) 200910306669.2

(51) Int. Cl. H02P 6/00

(52) U.S. Cl. 318/400.01

(57) ABSTRACT

A system of computer fan control reduces vibration values and prominence ratios of a number of computer fans. A control chip outputs a phase setting control instruction to a PWM chip. The PWM chip outputs a number of out-of-phase PWM signals to rotate the number of computer fans according to the phase setting control instruction.

### BACKGROUND

1. Technical Field

The present disclosure relates to computer cooling, and particularly to a computer fan control system.

2. Description of Related Art

Frequently, a computer system includes a motherboard with various chips such as central processing units (CPUs) mounted thereon, and a storage device such as a hard disk drive, each of which is known to generate heat when operating. Typically, fans are mounted on the motherboard to dissipate the heat. Generally, in-phase pulse width modulation (PWM) signals from a motherboard are used to drive the fans, around which magnetism generating members easily form during operation. As a result, mechanical and electrical components of the fans can generate high vibration and prominence ratios, and efficiency of the computer system is thus reduced.

### BRIEF DESCRIPTION OF THE DRAWINGS

FIG. 1 is a block diagram of an exemplary embodiment of a computer fan control system.

FIG. 2 is an exploded, isometric view of a computer fan of FIG. 1, in accordance with an embodiment.

FIG. 3 is a waveform diagram of in-phase PWM signals.

FIG. 4 is a waveform diagram of out-of-phase PWM signals.

FIG. 5 is a contrast histogram diagram showing a prominence ratio generated by the plurality of computer fans when receiving the in-phase PWM signals in comparison with a prominence ratio generated by the plurality of computer fans when receiving the out-of-phase PWM signals.

FIG. 6 is a contrast histogram diagram showing a vibration value generated by the plurality of computer fans when receiving the in-phase PWM signals in comparison with a vibration value generated by the plurality of computer fans when receiving the out-of-phase PWM signals.

### DETAILED DESCRIPTION

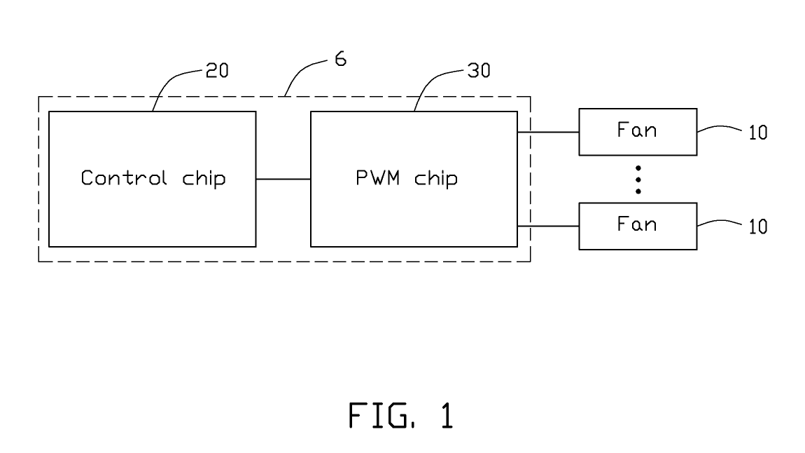

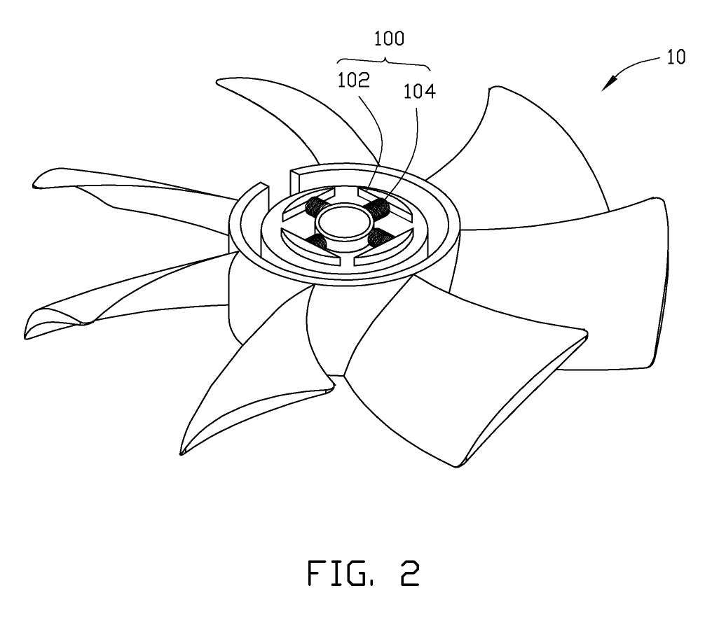

Referring to FIGS. 1 and 2, an exemplary embodiment of a system 6 for controlling a plurality of computer fans 10 is shown. The system 6 includes a control chip 20 and a pulse width modulation (PWM) chip 30. The PWM chip 30 is connected to the plurality of computer fans 10 and to the control chip 20. The control chip 20 may be a microcontroller or other kind of chip.

Each computer fan 10 includes four magnetism generating members 100, each including a supporting member 102 of silicon and copper and an induction coil 104 wound around a part of the supporting member 102. The four magnetism generating members 100 are spaced apart from one another in the shape of a cross. When electronic current passes through the magnetism generating members 100, a magnetic field is generated which repels a magnetic field produced by a magnet (not shown) in the fan 10, thereby rotating the computer fan 10. In other embodiments, more than four or fewer magnetism generating members 100 can be deployed.

The control chip 20 stores a setup program to output a phase setting control instruction to the PWM chip 30.

The PWM chip 30 outputs a plurality of out-of-phase PWM signals to induce the magnetism generating members 100 according to the phase setting control instruction, the plurality of computer fans 10 rotate and the magnetism generating members 100 of the plurality of computer fans 10 are in different locations. In this embodiment, the computer fans 10 rotate at the same speed. Because the control chip 20 directs the PWM chip 30 to output the out-of-phase PWM signals to the plurality of computer fans 10, vibration and prominence ratio generated by the plurality of computer fans 10 do not overlap, the magnetism generating members 100 of the plurality of computer fans 10 are not aligned with each other during rotation, and the system 6's vibration value and prominence ratio generated by the plurality of computer fans 10 are considerably lower than in conventional systems.

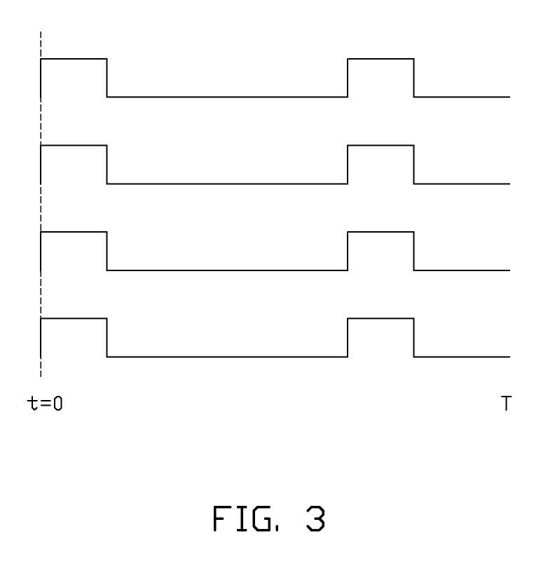

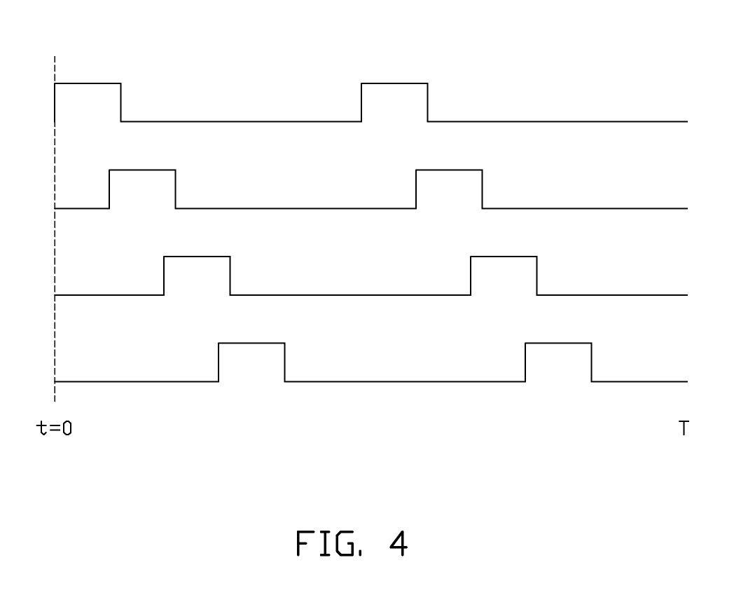

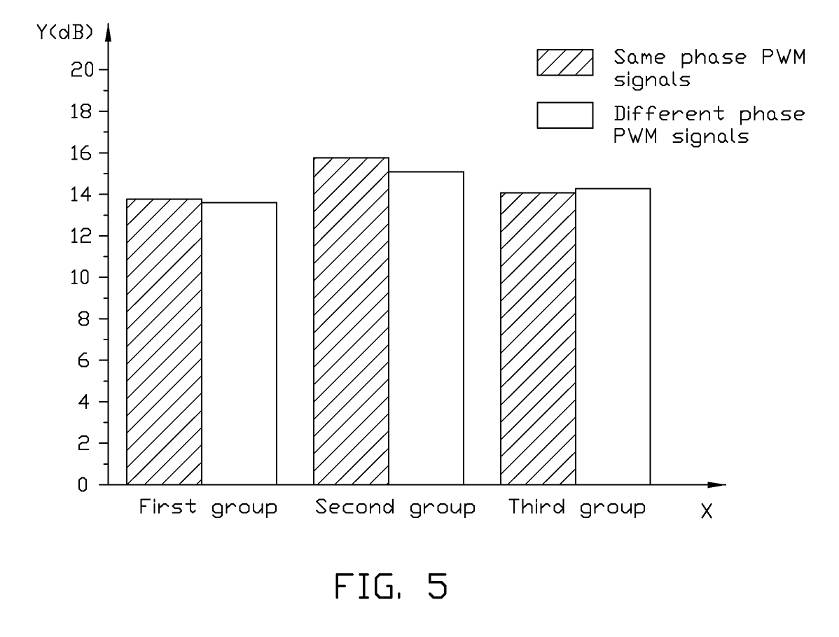

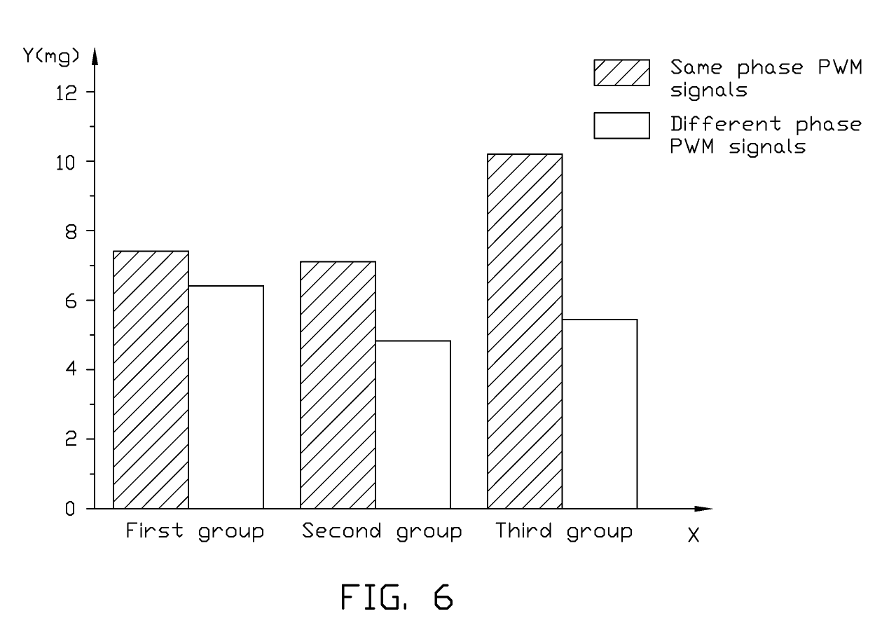

The following describes experimental measurement of vibration value and prominence ratio generated by the plurality of computer fans 10. Three groups of computer fans were measured, each group including four computer fans 10. Each of the computer fans 10 receiving the in-phase PWM signals (shown in FIG. 3) and the out-of-phase PWM signals (shown in FIG. 4) was measured three times. Each group of four computer fans 10 received PWM signals whose difference among the phase PWM signals one another were 360/4=90°, that is, 360° are divided equally among the number of computer fans. Averages of vibration values and prominence ratios generated by the plurality of computer fans when receiving the in-phase PWM signals and the out-of-phase PWM signals were calculated, and comparisons with vibration values and prominence ratios are shown in FIGS. 5 and 6. FIGS. 5 and 6 are contrast histogram diagrams showing a prominence ratio generated by the plurality of computer fans when receiving the in-phase PWM signals (blank histogram) in comparison with a prominence ratio generated by the plurality of computer fans when receiving the out-of-phase PWM signals(slash histogram). FIGS. 5 and 6 show that prominence ratio generated by the plurality of computer fans when receiving the out-of-phase PWM signals can be reduced by 1.4% in comparison with a prominence ratio generated by the plurality of computer fans when receiving the in-phase PWM signals, and the vibration value can be reduce by 32.5%. From the results, it can be seen that when the plurality of computer fans receive the out-of-phase PWM signals, the vibration value of the plurality of computer fans is significantly reduced, as is the prominent ratio.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A system for controlling a plurality of computer fans, the system comprising:
a control chip to output a phase setting control instruction; and
a pulse width modulation (PWM) chip connected to the plurality of computer fans and the control chip, outputting a plurality of out-of-phase PWM signals to rotate the plurality of computer fans according to the phase setting control instruction.

2. The system of claim 1, wherein each computer fan comprises four magnetism generating members, and each magnetism generating member comprises a supporting member and an induction coil wound around a part of the supporting member spaced from one another, wherein when current passes through the magnetism generating members, the magnetism generating members produce a magnetic field which repels a magnetic field in the fan to rotate the computer fan, and the magnetism generating members of the plurality of computer fans are not aligned with each other during rotation.

3. The system of claim 2, wherein the number of magnetism generating members is even.

4. The system of claim 2, wherein the magnetism generating members are silicon and copper.

5. The system of claim 1, wherein a difference between each of the phase PWM signals is equal to 360° divided by the number of computer fans.

6. The system of claim 1, wherein the control chip is a microcontroller.
